(19) United States
(12) Patent Application Publication
(10) Pub. No.: US 2018/0273005 A1
(43) Pub. Date: Sep. 27, 2018

(54) SYSTEM AND METHOD FOR STEERING COMPENSATION

(71) Applicant: Faraday&Future Inc., Gardena, CA (US)

(72) Inventors: Timm Sabastian Redder, Ladera Ranch, CA (US); Anil Paryani, Cerritos, CA (US); Jana Mahen Fernando, Torrance, CA (US); Matthew K. Lubbers, Manhattan Beach, CA (US)

(21) Appl. No.: 15/763,606

(22) PCT Filed: Sep. 26, 2016
(86) PCT No.: PCT/US2016/053690

§ 371 Date: Mar. 27, 2018

Related U.S. Application Data
(60) Provisional application No. 62/233,929, filed on Sep. 28, 2015.

(51) Int. Cl. B60T 8/1755; B60T 8/88; B62D 5/04; B62D 9/00

(52) U.S. Cl. CPC B60T 8/17551; B60T 8/885; B62D 5/0484; B60T 2270/413; B60T 2260/022; B60T 2270/402; B62D 9/005

(57) ABSTRACT

Systems and methods for performing steering compensation can include determining vehicle operation conditions, determining vehicle operations to perform in order to advance a vehicle along a desired trajectory, and performing the determined vehicle operations. The vehicle operations can include automated braking and torque vectoring. Torque vectoring can be performed using one or more differentials or one or more torque motors, each torque motor configured to apply torque to an individual wheel of the vehicle.

### BACKGROUND OF THE INVENTION

### Field of the invention

This disclosure relates generally to the field of automotive technology, and more particularly to systems and methods for automotive steering.

### Description of the Related Art

Electronic power steering (EPS) systems work to supplement the manual steering contribution of a driver in order to decrease the effort required to change the trajectory of a vehicle by applying additional torque to one or more components of the steering systems using an electronic steering motor. For example, in an EPS rack-and-pinion steering system, a steering motor can provide additional torque to the rack-and-pinion gear set to assist the driver in steering the vehicle. Actuation of the steering motor can be controlled by a computing module and based on data from one or more sensors including the position of the steering column and the manual torque provided by the driver. In the event of a steering motor malfunction or failure, a driver may continue to steer the vehicle manually, albeit with additional effort.

In an automated or partially automated vehicle, a steering motor may be used to provide the entirety of the steering torque required to change the vehicle's trajectory. Advanced Driver Assistance Systems (ADAS), are traditionally categorized into several levels of automated assistance. In a Level 3 ADAS, a driver can yield control to a vehicle without continuous monitoring, but may be required to take occasional control under certain conditions. In a level 3 ADAS system utilizing a single steering motor for a steering operation, failure of the steering motor requires driver input and control to complete the steering operation. The necessity of alerting the driver and the driver's ability to take control of the steering operation in a timely manner can create significant safety concerns.

Prior efforts to compensate for steering motor failure have incorporated a double steering motor system, in which a second steering motor can complete a steering operation following failure of a first steering motor. However, incorporating two steering motors into a vehicle can increase cost and decrease efficiency. Furthermore, incorporating a second steering motor increases the size of the EPS system, necessitating more space within the vehicle.

### SUMMARY OF THE INVENTION

In accordance with one aspect of the present invention, systems and methods are provided for steering compensation.

In one embodiment, a system for steering compensation in a vehicle is provided. The system includes a plurality of sensors configured to detect vehicle operation data and one or more steering components, the steering components comprising one or more of an electric steeling motor, one or more torque motors, one or more differentials, and one or more brakes. The system also includes a power-train controller configured to receive data from the plurality of sensors, determine one or more vehicle operations to advance the vehicle along a desired trajectory, and provide instructions to one or more of the steering components to perform the determined vehicle operations.

In another embodiment, a method for steering compensation in a vehicle is provided. The method includes determining vehicle operation conditions affecting the trajectory of the vehicle, determining if steering compensation is required based on a desired trajectory of the vehicle, determining one or more vehicle operations to advance the vehicle along the desired trajectory based on the vehicle operation conditions, the one or more vehicle operations comprising one or more of torque vectoring, automated braking, and actuating a steeling motor of an electronic power steering system, and performing the determined vehicle operations.

In another embodiment, a method for compensating for a malfunctioning steering motor is provided. The method includes performing one or more of torque vectoring and braking.

### BRIEF DESCRIPTION OF THE DRAWINGS

FIG. 1 depicts an exemplary system for steering a vehicle in accordance with an illustrative embodiment of the present disclosure.

FIG. 2 depicts an example of a steering operation in accordance with an illustrative embodiment.

FIG. 3 depicts an example of a steering operation in accordance with an illustrative embodiment.

FIG. 4 depicts an example of a steering operation in accordance with an illustrative embodiment.

FIG. 5 depicts a chart illustrating a set of potential inputs and potential resulting vehicle operations for a steering compensation system in accordance with an illustrative embodiment of the present disclosure.

FIG. 6 depicts a flowchart of one embodiment of a process for steering compensation in accordance with an illustrative embodiment of the present disclosure.

FIGS. 7A & 7B illustrate power distribution among various modules of a vehicle in accordance with embodiments of the present disclosure.

FIGS. 8A-8C illustrate various exemplary chassis CAN layouts in a vehicle in accordance with embodiments of the present disclosure.

FIG. 9 illustrates exemplary modules of a vehicle chassis that can facilitate deceleration of the vehicle in a number of different ways in accordance with embodiments of the present disclosure.

FIG. 10 illustrates exemplary modules of a vehicle chassis that can facilitate steering of the vehicle in a number of different ways in accordance with embodiments of the present disclosure.

### DETAILED DESCRIPTION OF THE PREFERRED EMBODIMENT

The present disclosure provides systems and methods for steering compensation. In a traditional electronic power steering operation, the trajectory followed by a vehicle may be the result of several inputs, including manual inputs from a driver, such as manual steering torque, manual steering column positioning, manually controlled motor torque, and manual brake application, as well as steering torque provided by a steering motor. In accordance with illustrative embodiments of the present disclosure, systems and methods are provided for improved steering operations through the use of one or more of automated braking action and automated torque vectoring, optionally in conjunction with one or more driver inputs and/or steering motor actuation.

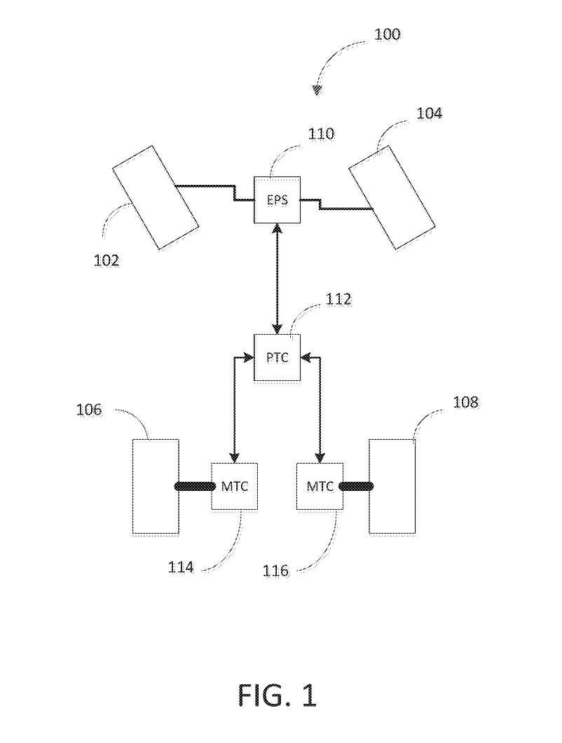

FIG. 1 shows a system 100 for steering a vehicle in accordance with an illustrative embodiment of the present disclosure. In this embodiment, the system 100 includes a four wheel vehicle arrangement including a front left wheel 102, a front right wheel 104, a rear left wheel 106, and a rear right wheel 108. It should be understood that the disclosed systems and methods can also be adopted in a vehicle with a different number of wheels. Each wheel further includes a brake (not shown). The system 100 further includes an EPS system 110 having an electronic power steering motor, a power-train controller (PTC) 112, a rear left motor 114, and a rear right motor 116.

The trajectory of the vehicle can be altered by actuation of one or more of the EPS system 110, the rear left motor 114, the rear right motor 116, and one or more of the brakes. For example, the steering motor of the EPS system 110 can be configured to provide steering torque for altering the positioning of the front left wheel 102 and front right wheel 104. The motors 114 and 116 are configured to control the torque provided to rear left wheel 106 and rear right wheel 108, respectively. Having separate motors 114 and 116 is one way to allow for torque vectoring, in which the torque provided to each wheel can be varied. By applying varied torques to the rear left wheel 106 and rear right wheel 108 the trajectory of the vehicle may be affected. Similarly, the brakes can be configured so that one or more of the brakes may be controlled individually. Applying varied brake force to individual wheels can also affect the course of the vehicle.

The PTC 112 can regulate vehicle function by receiving vehicle operation information and, in response, adjusting vehicle operation by controlling one or more vehicle components. The PTC 112 can be configured to receive data from one or more sensors configured to detect vehicle operation data. The PTC 112 can further include a processor for processing the received data and, based on the received data, determining one or more vehicle operations. In response to determining a vehicle operation, the PTC 112 can send commands to one or more vehicle components to perform one or more vehicle operations.

As depicted in FIG. 1, the PTC 112 can be in communication with the EPS system 110, the rear left motor 114, and the rear right motor 116. The PTC 112 may also communicate with the brakes. Based on data received from one or more sensors, the PTC 112 can determine current vehicle operation conditions, such as a current steering angle of the vehicle. In response to the vehicle operation conditions, the PTC 112 can determine one or more vehicle operations and send commands to one or more components of the system 100, such as the EPS system 110, the rear left motor 114, the rear right motor 116, and the brakes, to direct the vehicle over or nearly over a desired trajectory.

Relevant vehicle operation conditions may vary based on the type of vehicle and availability of vehicle components. For example, in a non-automated or partially automated vehicle, the PTC 112 can also take driver inputs into account when determining vehicle operations to direct the vehicle over or nearly over a desired trajectory. For example, the PTC 112 may account for manual steering torque, manual steering column positioning, manually controlled motor torque, and manual brake application. The PTC 112 may also determine, based on data from one or more sensors, that one or more steering components has malfunctioned or failed. In response, the PTC 112 can determine one or more vehicle operations utilizing only functioning vehicle components to help maintain the vehicle along or at least closer to along a desired trajectory.

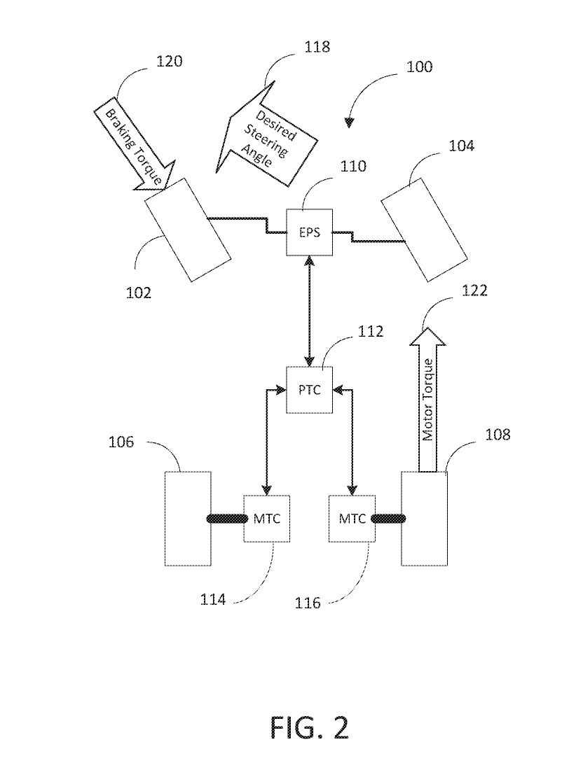

FIG. 2 depicts an example of a steering operation in accordance with an illustrative embodiment. In the example depicted in FIG. 2, the vehicle is undergoing a left turn in accordance with an automated steering function controlled by an ADAS, having wheels 102 and 104 angled to the left. A desired trajectory, indicated by a desired steering angle represented by arrow 118, can be known by an electronic control unit (ECU) of the ADAS. While undergoing the left turn, the steering motor of the EPS 110 has failed. The PTC 112 can detect the steeling angle of the vehicle, and based on the detected steering angle as compared to a desired steering angle for example, determine that the steering motor of the EPS system 110 has failed. In response, the PTC 112 can determine one or more vehicle operations in order to direct the vehicle over ore nearly over the desired course of motion. Generally, applying a braking torque to one or more of the inside wheels, wheels 102 and 106 in the example shown in FIG. 2, will increase torque steer. Applying motor torque to one or more of the outside wheels, wheels 104 and 108 in the example shown in FIG. 2, can also increase torque steer. Arrows 120 and 122 depict an example of vehicle operations for maneuvering the vehicle over or nearly over a trajectory indicated by the desired steering angle represented by arrow 118. Arrow 120 represents a braking torque applied to front left wheel 102. Arrow 122 represents a motor torque applied to rear right wheel 108 by rear right motor 108. In the example of FIG. 2, the length of arrows 120 and 122 is representative of the magnitudes of the braking torque and motor torque, respectively. Application of the braking torque and motor torque represented by arrows 120 and 122 can cause the vehicle to follow the desired trajectory indicated by the desired steering angle represented by arrow 118.

In some embodiments involving the malfunction or failure of one or more steering components, the system 100 may further include an alert system for notifying a user. The alert system may include one or more visual, auditory, or tactile stimuli.

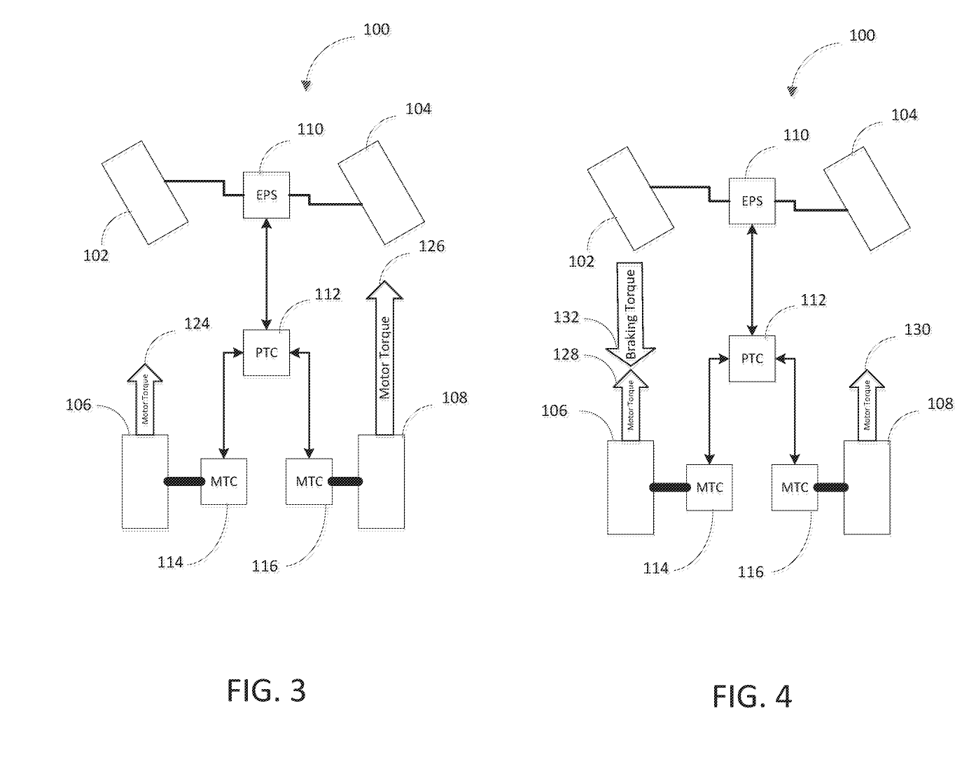

FIGS. 3 and 4 depict additional examples of steering operations for performing a left turn under the conditions described with respect to FIG. 2 in accordance with an illustrative embodiment. FIG. 3 shows an arrow 124 representing a motor torque applied to the rear left wheel 106 by the rear left motor 114 and an arrow 126 representing a motor torque applied to the rear right wheel 108 by the rear right motor 116. The size of the arrows 124 and 126 are indicative of the magnitude of the torques. As depicted in the example, the rear right motor 116 is generating a greater torque than the rear left motor 114, causing the vehicle to steer to the left.

FIG. 4 shows an arrow 128 representing a motor torque applied to the rear left wheel 114 by rear left motor 114 and an arrow 130 representing a motor torque applied to the rear right wheel 108 by the rear right motor 116. The motor torques represented by arrows 128 and 130 are of equal magnitudes. FIG. 4 further shows an arrow 132 representing a braking torque applied to wheel 106. The braking torque represented by arrow 132 can lead to a lower torque on wheel 106 in comparison to wheel 108, causing the vehicle to steer to the left.

Although the examples depicted in FIGS. 2-4 describe steering operations in response to the failure of an electric steering motor during an automated steering function, the principles described may also apply in embodiments including one or more of manual steering and a functioning steering motor. In an embodiment in which a driver is performing manual steering, one or more automated features, such as automated torque vectoring, automated braking, and electronic power steering may be used to supplement the manual steering contribution of the driver. In an embodiment in which a vehicle is undergoing automated steering functions, any combination of automated torque vectoring, automated braking, and electronic power steering may be used to advance the vehicle along or at least closer to along a desired trajectory.

As described above, during an automated steering operation, a desired trajectory may be known by the ADAS. In an embodiment involving manual steering, the desired steering trajectory may be determined based on one or more driver inputs, such as manual steering torque, manual steering column positioning, manually controlled motor torque, and manual brake application.

Although the embodiments described in FIGS. 1-4 depict only a rear left motor and a rear right motor, it is contemplated that any of the wheels 102, 104, 106, and 108 may include a motor for providing individual torque. In some embodiments each of the wheels 102, 104, 106, 108 may include an individual torque motor for providing torque vectoring. In other embodiments, only the front wheels 102 and 104 include individual torque motors. Some embodiments may include only a single electric motor. In other embodiments, torque vectoring is provided by one or more differentials, gear systems which allow for an outer wheel to rotate faster than an inner wheel. The system 100 can include a differential between the rear wheels, the front wheels, or both the rear and front wheels.

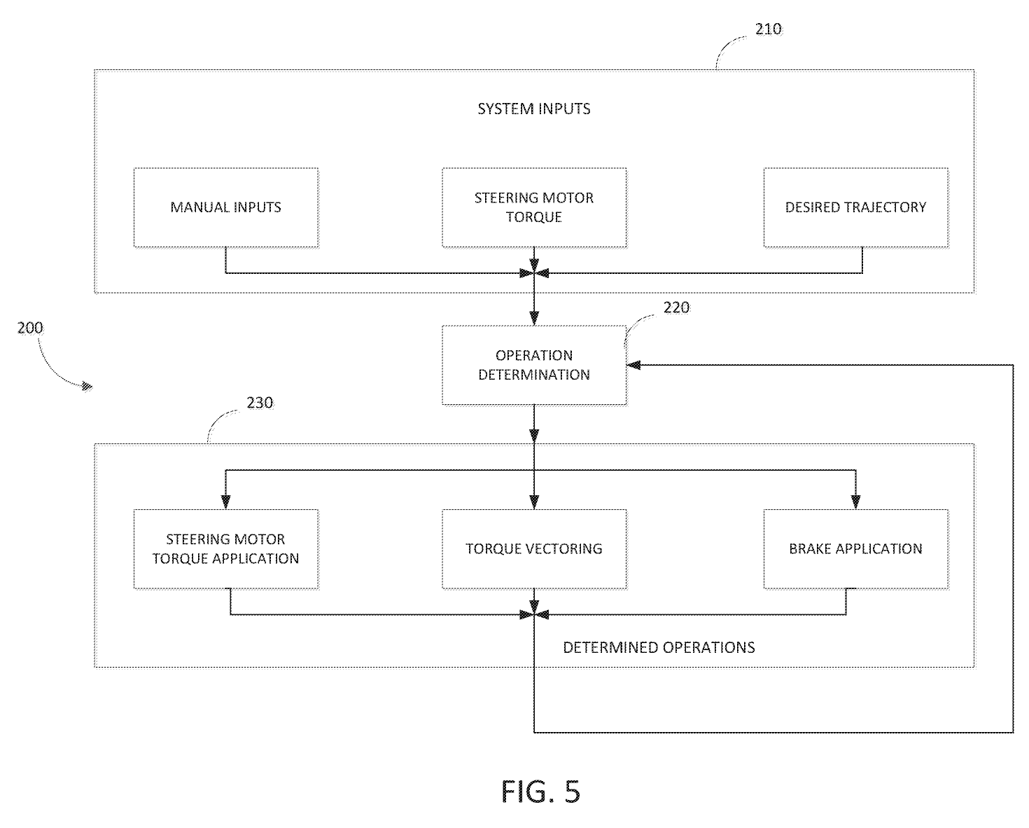

FIG. 5 depicts a chart 200 showing a set of potential inputs and potential resulting vehicle operations for a steering compensation system in accordance with an illustrative embodiment of the present disclosure. Box 210 shows a set of potential inputs for a steering compensation system, such as the system 100 described with reference to FIGS. 1-4. The system inputs can be used by a PTC to determine a set of vehicle outputs in order to steer a vehicle over or nearly over a desired trajectory. System inputs can include manual inputs initiated by a driver of the vehicle that affect the vehicle's trajectory. Examples include manual steering torque, manual steering column positioning, manually controlled motor torque, and manual brake application. System inputs can also include torque provided by a steering motor of an EPS system, such as EPS system 110 depicted in FIGS. 1-4 and desired steering trajectory. In some embodiments, the desired steering trajectory is determined by an ADAS ECU. In some embodiments, other inputs, such as manual inputs are used to determine the desired trajectory. Further system inputs can include data collected by one or more vehicle sensors. A PTC, such as PTC 112 can receive the system inputs and determine one or more vehicle operations to achieve the desired trajectory based on the inputs received. Box 220 represents such an operation determination. Following determination of the vehicle operations, the PTC can control one or more elements of a steering compensation system, such as the EPS, one or more torque motors, one or more differentials, and one or more brakes to achieve the desired trajectory. A set of potential outputs are shown in box 230. Potential outputs can include the application of steering motor torque, torque vectoring, and brake application to one or more wheels as described above with respect to FIGS. 1-4. Torque vectoring can be achieved by actuating one or more motors configured to apply torque to individual wheels or by use of one or more differentials. The outputs applied to the vehicle can be tracked, detected, or received, by the PTC for use in further vehicle operation determinations.

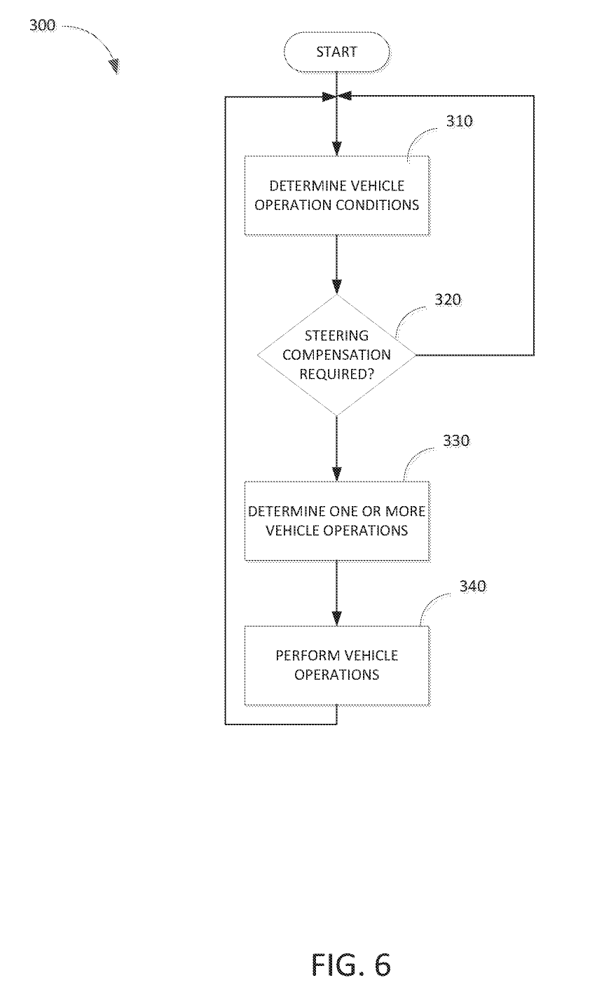

FIG. 6 depicts a flowchart of one embodiment of a process 300 for steering compensation in accordance with an illustrative embodiment of the present disclosure. The process 300 can begin at a step 310, wherein vehicle operation conditions are determined. The vehicle operation conditions can be determined based on sensor data received by a PTC and can include various conditions affecting the trajectory of a vehicle. For example, conditions may include steering angle information, manual steering torque information, steering column positioning information, EPS steering motor torque information, manual braking application information, automated braking application information, manually controlled motor torque information, automated motor torque information, and desired trajectory information.

After vehicle operation conditions are determined, the process 300 can move to a decision step 320, wherein a determination can be made whether steering compensation is required. For example, compensation may be required if it is determined, based on the vehicle operation conditions received in step 310, that the vehicle is not operating to achieve a desired trajectory. If a determination is made that steering compensation is not required, the process 300 can return to step 310.

If a determination is made that steering compensation is required, the process can move to a step 330, wherein one or more vehicle operations can be determined in order to direct the vehicle along or at least closer to along the desired trajectory. Vehicle operations can include one or more of actuating a steering motor of an EPS system, torque vectoring, and brake application. The vehicle operations can be determined by the PTC based on one or more of the vehicle operation conditions. For example, the PTC may determine based on the steering angle that the steering motor of the EPS system has failed during the performance of a left turn. Consequently, the PTC may determine that motor torque should be applied to the rear right wheel and braking torque should be applied to the front left wheel in order to advance the vehicle over or nearly over the left turn trajectory.

After the vehicle operations are determined, the process 300 can move to a step 340, wherein the determined vehicle operations are performed by one or more vehicle components, such as a steering motor, one or more torque motors, one or more brakes, and one or more differentials in response to a command from the PTC. After the vehicle operations are performed, the process can return to step 310.

The above paragraphs disclose various systems and methods for steering compensation in case one or more steering modules (e.g., EPS) fail. In addition to steering compensation, other types of redundancies can be built into the powertrain of a vehicle to ensure that the vehicle can maintain a minimum level of operation (e.g., deceleration and steering) even when certain parts of the powertrain fails.

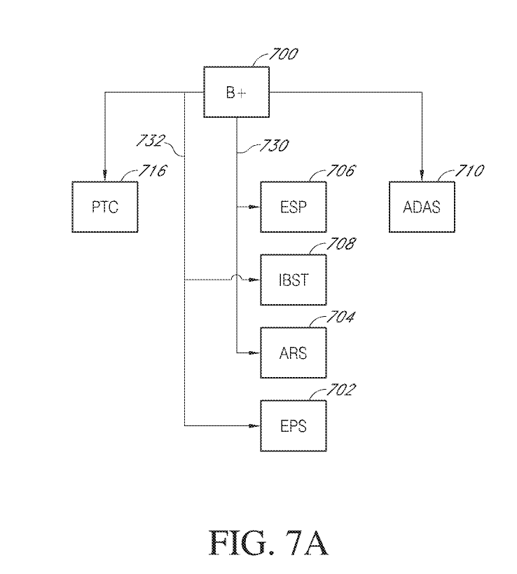

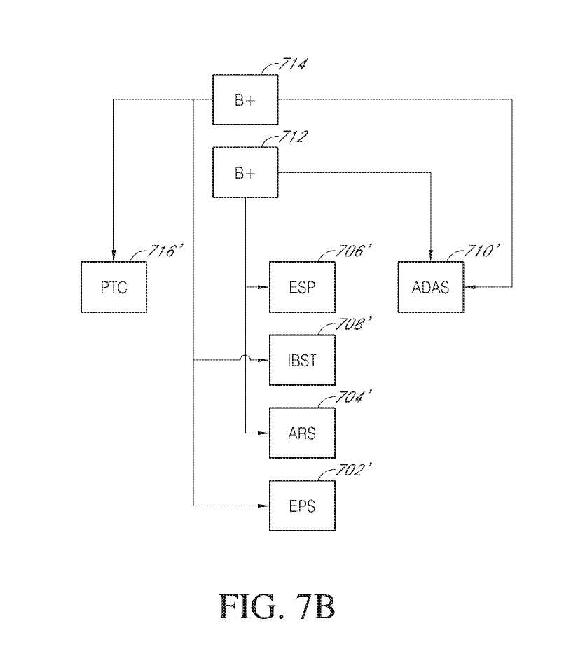

Various levels of redundancy can be built in the power distribution and/or chassis Controller Area Network (CAN) layout of the vehicle chassis. FIG. 7a illustrates one exemplary power distribution among the various modules of a vehicle, according to an embodiment of the present disclosure. It should be understood that the word “module” can refer to one or more ECUs of a vehicle. As illustrated, power can be provided by a single battery 700 to one or more modules including, for example, an EPS 702, an active rear steering (ARS) system 704, an electronic stability program (ESP) 706, and an electric brake system 708 (e.g., Bosch's iBooster system). The battery 700 can be a 12v battery suitable for use in a vehicle.

The EPS system 702 can be configured to control the steering of the front wheels (not shown) of the vehicle. The ARS system 704 can steer the rear wheels (not shown) of the vehicle. The ESP 706 can assist in steering the vehicle by applying brakes to individual wheels asymmetrically when a loss of traction is detected. During normal driving, the ESP 706 can continuously monitor steering and vehicle direction. The ESP 706 can compare the driver's intended direction which can be determined based on the measured steering wheel angle in comparison to the vehicle's actual direction, which can be determined through measured lateral acceleration, vehicle rotation (yaw), and individual road wheel speeds. When the ESP 706 detects that the vehicle is not going where the driver is steering, it can estimate the direction of the skid, and then apply various braking forces to individual wheels to steer the vehicle in the direction intended by the driver. The electric brake system 708 (e.g., Bosch's iBooster) can apply brakes to the wheels in response to detecting a pressing of the brake pedal by the driver or receiving a signal from a processer such as the ADAS control module 710. The battery 700 can also be connected to a PTC 716.

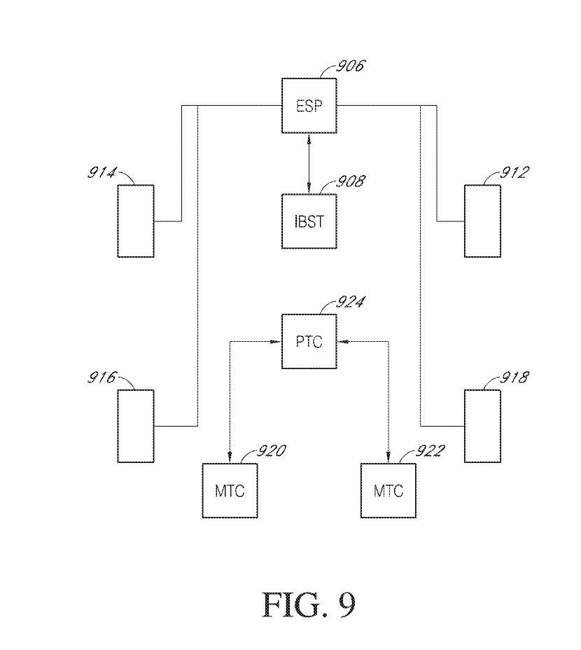

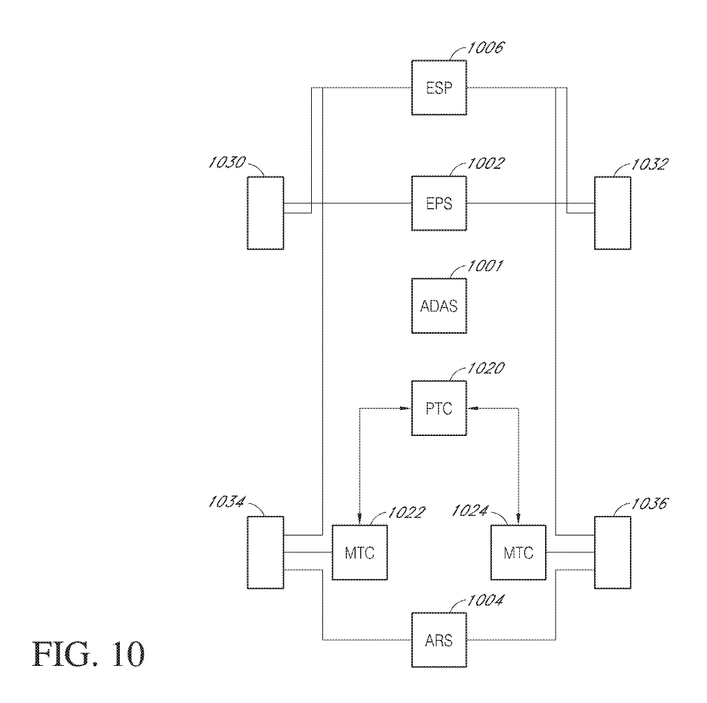

In the power distribution diagram of FIG. 7A, the battery is connected to the ESP 706 and. ARS system 704 by a first power supply line 730 and the electric brake system 708 and EPS system 702 by a second power supply line 732. The two power supply lines 730, 732 can provide a first level of redundancy to ensure that at least some of the modules 702, 704, 706, 708 can still be powered when there is a failure of one of the power supply lines. For example, if power supply line 732 fails, both the electric brake system 708 and the EPS system 702 would lose power and fail. But because the ESP 706 and ARS system 704 are connected to the battery 700 via power supply line 730, they can still receive power to provide braking and steering, respectively, for the vehicle, as will be discussed below in view of FIGS. 9 and 10.

One issue with the power distribution shown in FIG. 7A is that it does not provide sufficient safeguard against a single point of failure at the battery 700. In other words, if the battery 700 fails, all the modules (e.g., ESP 706, electric brake system 708, ARS system 704, EPS system 702) will lose power because they are all receiving power from the battery 700. As a consequence, the vehicle may lose steering and/or braking. To prevent a complete loss of steering and/or braking, a second level of redundancy in power distribution can be incorporated, as shown in FIG. 7B.

According to FIG. 7B, two batteries 712, 714 can provide power to the various modules including, for example, an EPS system 702′, an ARS system 704′, an ESP 706′, and an electric brake system 708′. Both batteries 712, 714 can be 12v batteries. Battery 712 can provide power to the ARS system 704′ and the ESP 706′. Battery 714 can provide power to EPS system 702′ and the electric brake system 708′. Both batteries 712, 714 can be connected to an ADAS controller 710′ and a PTC 716′. In this setup, EPS system 702′ and the electric brake system 708′ can, for example, provide steering and braking, respectively, for the vehicle during normal driving. If battery 714, which powers EPS system 702′ and the electric brake system 708′, fails, the other battery 712 can continue to supply power to ARS system 704′ and ESP 706′. In turn, ARS 704′ can steer the vehicle on its own without a functioning EPS 702. Similarly, ESP 706′ can provide braking for the vehicle even when the electric braking system 708′ is no longer receiving power from battery 714. As such, the 2-battery setup of FIG. 7B can provide redundancy in power distribution to the various modules of the steering and braking system of the vehicle to ensure that at least some of these modules will remain functional in case one of the batteries fails. It should be understood that the modules illustrated in FIGS. 7A and 7B are exemplary, a similar setup can be used for providing redundancy in power distribution to other modules in the vehicle.

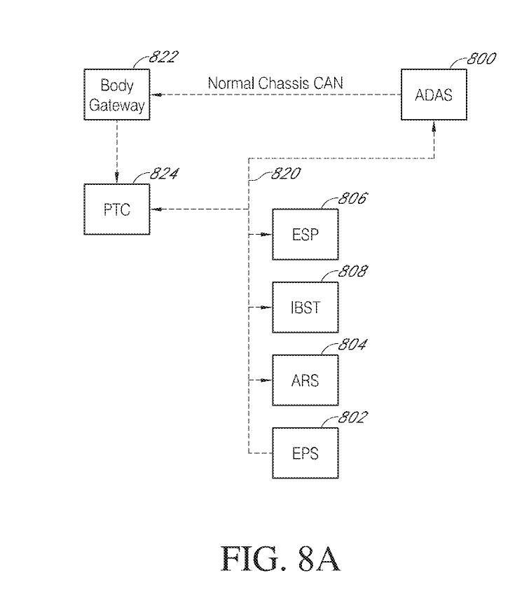

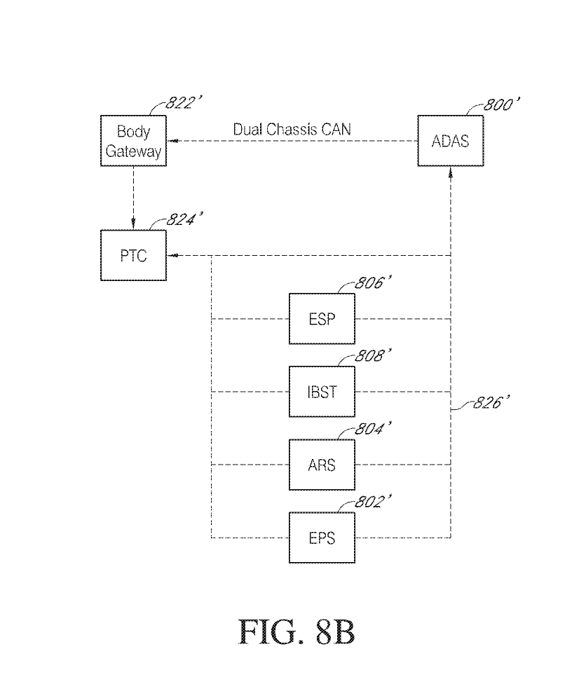

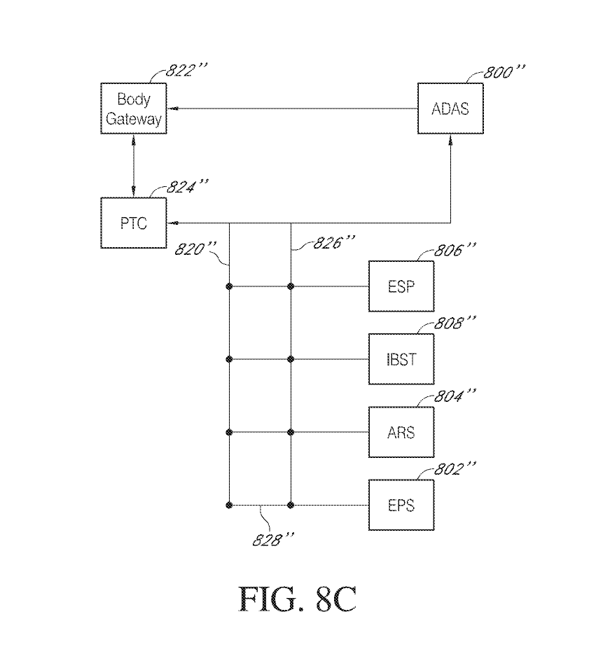

FIGS. 8A-8C illustrate various exemplary chassis CAN layouts in a vehicle. FIG. 8A illustrates a CAN bus layout in which various modules including an EPS system 802, an ARS system 804, an ESP 806, and an electric brake system 808 (e.g., Bosch's iBooster) are connected to an ADAS controller 800 and a PTC 824 via a single CAN bus 820. A body gateway module 822 that communicates with, for example, the doors, wipers, and seats of the vehicle, can also optionally be connected to the same CAN bus 820. Because all the modules are connected to the same CAN bus 820, if there is a loss of connection at one point, the ADAS controllers 800 and the powertrain controller 824 would lose communication with all the other modules including EPS system 802, system ARS 804, ESP 806, and the electric brake system 808 on the CAN bus 820.

one solution to ensure that at least some of the modules can still communicate with the controllers is the chassis CAN layout illustrated in FIG. 813, where each of the modules including an EPS system 80 an ARS system 804′, an ESP 806′, and an electric brake system 808′ is connected to an ADAS controller 800′ and a powertrain controller 824′ via two separate CAN buses 820′, 826′. This allows at least some if not all the modules 802′, 804′, ‘806’, 808′ to be in communication with the ADAS controller 800′ and the powertrain controller 824′ even when one of the CAN buses 820′, 826′ fails. For example, in normal operation, the ADAS module 800′ can communicate and control the EPS system 802′, ARS system 804′, ESP 806′ and the electric brake system 808′ via either CAN bus 820′ or CAN bus ‘826’ or both. When a loss of communication over CAN bus 820′ is detected, all communication between the ADAS module 800′ and the other modules 802′, 804′, 806′, and 820 can be facilitated via the second CAN bus 826′.

One disadvantage of the CAN bus layout of FIG. 8b is that it requires each of the modules (or ECUs) 802′, 804′, 806′, 808′ to have two separate pairs of pins (each pair including an input pin and an output pin) to be able to connect to the two CAN buses 820′, 826′. This can be a significant change to the ECU layout, which can increase the cost of the ECUs 802′, 804′, 806′, 808′.

FIG. 8C illustrates a series/parallel chassis CAN layout that allows each ECU to connect to two CAN buses 820″, 826″ in parallel while requiring only one pair of pins (i.e., one for input and one for output). As illustrated, a single connection from each module can connect each of an EPS system 802″, an ARS system 804″, an ESP 806″, and an electric brake system 808″ to both CAN buses 820″, 826″ in parallel. For example, ESP 802″ is connected to both CAN buses 820″, 826″ via a connection 828″. As such, the ICU (e.g., the ESP 802″) does not have to he modified to include additional pins to support one or more additional connections, as shown in the chassis CAN layout of FIG. 8B. Each of the CAN buses 820″, 826″ can connect the ECUs (e.g., EPS system 802″, ARS system 804″, ESP 806″, and the electric brake system 808″) to an ADAS controller 800″ and a PTC 824″ (collectively as “controller”) and other modules such as a Body Gateway module 822″. The chassis CAN layout of FIG. 8C can ensure that the ECUs 802″, 804″, 806″, 808″ are able to communicate to the controllers 800″, 824″ so long as one of the CAN buses 820″, 826″ has not suffered a failure.

As discussed above, one of the advantages of adding redundancy to the power distribution and/or chassis CAN layout is that when certain modules (e.g., ECUs) lose power and/or are cut off from the controllers due to a failure of a CAN bus, other modules (e.g., ECUs) can remain operational and in communication with the controllers to provide essential functions such as steering and braking of the vehicle. FIGS. 9 and 10 illustrate exemplary scenario in which the redundancy in power distribution and/or chassis CAN layout is relied upon to provide sufficient steering and braking for the vehicle even when certain modules fail.

FIG. 9 is a block diagram illustrating various modules of a vehicle chassis that can facilitate deceleration of the vehicle in a number of different ways. A chassis 900 of a vehicle is shown to include an ESP 906, an electric brake system (e.g., iBooster) 908, and a PTC 924. ESP 906 and the electric brake system 908 can he connected to the actuators of the brakes in each wheel 912, 914, 916, 918. The PTC 924 can be connected to a pair of rear motors 920, 922 that is capable of driving the two rear wheels of the vehicle independently.

Typically, under normal circumstance, when the driver applies pressure to the brake pedal (not shown), the electric brake system 908 can provide boost power using, for example, the torque of an electric motor (not shown). The power supplied by the booster can then be converted into hydraulic pressure in a standard master brake cylinder. The hydraulic pressure can in turn force the brakes of one or more of the wheels 912, 914, 916, 918 against a rotor of each wheel to slow down the vehicle. Similarly, ESP 906 can apply various braking forces to individual wheels in response to detecting that the vehicle is not going where the driver is steering.

When the electric brake system 908 fails, ESP 906 can still receive power and remain operational if the chassis has incorporated redundancy in its power distribution and CAN layout, as discussed above in view of FIGS. 7 and 8. Accordingly, ESP 906, which has its own vacuum pump, can build up pressure in the vacuum pump to actuate the brakes of wheels 912, 914, 916, 918. Alternatively, if ESP 906 fails, the electric brake system 908 can remain functional and actuate the brakes of wheels 912, 914, 916, 918 on its own to achieve deceleration of the vehicle. Even when no hydraulic pressure can be generated due, for example, to a failure of both ESP 906 and the electric brake system 908 or a leak in the hydraulic fluids, PTC 924 can actuate the rear motors 920, 922 to slow down the vehicle as discussed above in view of FIGS. 1-4.

FIG. 10 illustrates exemplary modules of a vehicle chassis that can facilitate steering of the vehicle in a number of different ways. As illustrated, these modules can include an ESP 1006, an EPS system 1002, an ARS system 1004 and an ADAS controller 1001. EPS system 1002 can control the direction of the front wheels 1030, 1032. ARS system 1004 can steer the rear wheels 1034, 1036. In normal driving, EPS system 1002 can provide steering for the vehicle. ARS system 1004 can complement EPS system 1002 in steering the vehicle. For example, ARS system 1004 can turn the rear wheels opposite of the front wheels to reduce the turning radius. Alternatively, ARS system 1004 can turn the rear wheels in the same direction of the front wheels to enhance stability.

When EPS system 1002 fails, ESP 1006 can command ARS system 1004 to steer the vehicle in a desirable direction according to input from the driver or the ADAS controller 1001. If both EPS system 1002 and ARS system 1004 fail, ESP 1006 can command the individual brake pressure to change the direction of a vehicle. An example of this was described above in view of FIG. 2. If EPS system 1002, ARS system 1004, and the hydraulics connecting ESP 1006 to the brakes all fail, ESP 1006 can command individual emergency park brakes to steer the vehicle. Even if EPS system 1002, ARS system 1004, hydraulics, and ESP 1006 all fail, a PTC 1020 can command the individual motors 1022, 1024 to use torque vectoring to steer the vehicle as described above in view of FIGS. 3 and 4.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of a” list of items refers to any combination of those items, including single members. As an example, “at least one of: a, b, or c” is intended to cover: a, b, c, a-b, a-c, and a-b-c.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication devices, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable medium may be a non-transitory storage medium. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Various embodiments of the invention have been described. These and other embodiments are within the scope of the following claims.

What is claimed:

1. A chassis control system of a vehicle comprising:
a first braking system configured to provide braking for the vehicle;
a second braking system configured to provide braking for the vehicle;
a first steering system configured to provide steering for the vehicle;
a second steering system configured to provide steering for the vehicle;
an Advanced Driver Assistance Systems (ADAS) configured to provide control signals to each of the first braking system, the second braking system, the first steering system, and the second steering system;
a first data bus connecting each of the first braking system, the second braking system, the first steering system, and the second steering system to the ADAS; and
a second data bus connecting each of the first braking system, the second braking system, the first steering system, and the second steering system to the ADAS;
wherein each of the first braking system, the second braking system, the first steering system, and the second steering system is connected to both the first data bus and the second data bus through a connection comprising a same pair of input and output pins.

2. The chassis control system of claim 1 wherein the first braking system comprises an electronic stability program (ESP).

3. The chassis control system of claim 2, wherein the second braking system comprises an electric braking system separate from the ESP.

4. The chassis control system of claim 1, wherein the first steering system comprises an electronic power steering (EPS) system.

5. The chassis control system of claim 4, wherein the second steering system comprises an active rear steering (ARS) system.

6. The chassis control system of claim 5, wherein the EPS system and the ARS system are configured to steer the vehicle independent of each other.

7. The chassis control system of claim 1, wherein the ADAS is configured to communicate with at least one of the first braking system and second braking system and at least one of the first steering system and second steering system via one of the first data bus and the second data bus if the other of the first data bus and the second data bus fails.
